(19) United States
(12) Patent Application Publication
(10) Pub. No.: US 2008/0178024 A1
(43) Pub. Date: Jul. 24, 2008

(54) Multilayered bus system

(75) Inventor: Hideki Kamegawa, Tokyo (JP)

Correspondence Address: Studebaker & Brackett PC, 1890 Preston White Drive, Suite 105, Reston, VA, 20191, US

(73) Assignee: Oki Electric Industry Co., Ltd.

(21) Appl. No.: 11/802,632

(22) Filed: May 24, 2007

(30) Foreign Application Priority Data
Feb. 15, 2006 (JP) 2006-037383

(51) Int. Cl. G06F 1/32; G06F 11/30

(52) U.S. Cl. 713/322; 713/340

(57) ABSTRACT

The present invention provides a multilayered bus system capable of performing transition to a power-saving mode reliably and rapidly. When a mode designation signal for designating the power-saving mode is outputted from a clock controller in response to mode setting information outputted from a CPU, respective arbiters respectively output response signals for prohibiting access to bus slaves to their corresponding bus masters. When the power-saving mode is designated by the mode designation signal, the response signal for prohibiting access is outputted from the arbiter, and an end signal indicating that the respective bus slaves do not perform data transfers for a predetermined period of time is outputted from a monitor, a control signal for stopping the supply of a system clock is outputted from the clock controller to a clock generator.

### BACKGROUND OF THE INVENTION

The present invention relates to a multilayered bus system which connects between a plurality of bus masters and a plurality of bus slaves using a plurality of common buses.

A multilayered bus system is one of such a type that a plurality of common buses are used to connect between a plurality of bus masters and a plurality of bus slaves, thereby avoiding such bus competition as developed in a conventional single-layer bus and making an improvement in throughput.

FIG. 2 is a configuration diagram of a conventional multilayered bus system.

The multilayered bus system is equipped with a connection matrix 10 which connects between bus masters 1a, 1b and 1c and bus slaves 2a and 2b in accordance with requests issued from the master side, a clock generator 30 which generates a system clock CLK, and a clock controller 20 which controls the operation of the clock generator 30.

The connection matrix 10 includes master ports 11a through 11c to which the bus masters 1a through 1c are respectively connected. Buffers 12a through 12c that temporarily hold write addresses, write data and the like are respectively connected to the master ports 11a through l1c. Connection controllers 13a through 13c, which respectively control connections to the slave side in accordance with the write addresses retained in the buffers, are connected to their corresponding buffers 12a through 12c. These connection controllers 13a through 13c are connected to a plurality of common buses 14, 15 and 16 that constitute a multilayer. Further, the connection matrix 10 has slave ports 19a and 19b to which the bus slaves 2a and 2b are respectively connected. These slave ports 19a and 19b are connected to the common buses 14 through 16.

The clock controller 20 outputs a control signal CON used for activating and stopping the system clock CLK, in accordance with instructions issued from a central processing unit (hereinafter called “CPU”) 1a corresponding to one bus master. The clock generator 30 controls the supply of the system clock CLK to its corresponding parts or sections in accordance with the control signal CON.

The operation of the multilayered bus system will next be explained.

Since the respective bus masters 1a through 1c can always be operated independently in the multilayered bus system, they are connected in such a manner that bus request signals BRQa through BRQc respectively outputted from the bus maters 1a through 1c are always set to a logical value “1” and fed back as response signals RESa through RESc as they are. Thus, when, for example, the CPU 1a issues write access to the bus slave 2a, a state in which each of the common buses is always available is notified thereto in accordance with the response signal RESa.

Next, the CPU 1a outputs each address and write data or the like for the bus slave 2a corresponding to a data writing destination. The address and data outputted from the CPU 1a are received at the master port 11a and temporarily written into the buffer 12a. Then, a write completion signal is fed back from the master port 11a to the CPU 1a. Thus, the CPU 1a can perform the next processing.

On the other hand, in the connection matrix 10, the connection controller 13a selects the unused common buses 14 through 16 in accordance with the write address held in the buffer 12a to connect to the slave port 19a, and transfers write data to the bus slave 2a through the slave port 19a.

Thus, since the write completion signals are fed back from the corresponding master ports 11a through 11c before the completion of the write access to the bus slaves 2a and 2b, the bus masters 1a through 1c can perform the next operations, and hence degradation in throughput due to access to each bus slave slow in access speed can be reduced.

Now, when the processing of the CPU 1a is ended and it proceeds to a standby state, the CPU 1a outputs mode setting information (for example, a logical value “1”) for designating a power-saving mode to the clock controller 20. The clock controller 20 writes the mode setting information supplied from the CPU 1a into its corresponding register. The value of the register is outputted as a control signal CON.

When the control signal CON supplied from the clock controller 20 is brought to “1”, for example, the clock generator 30 stops a system clock CLK supplied to the respective parts or sections. Thus, the operations of the respective parts operated in sync with the system clock CLK are stopped and the multilayered bus system proceeds to the power-saving mode.

It is necessary that when the system clock CLK is stopped, other bus masters 1b and 1c and the bus slaves 2a and 2b be also brought into a clock stoppable state as well as the CPU 1a. Therefore, the operations of the bus masters 1b and 1c are stopped by software before an instruction for transition to the power-saving mode. Further, when the multilayered bus system is returned to a normal operation mode, the processing of resuming the stopped operations of bus masters 1b and 1c by software is performed.

The above prior art refers to a patent document 1 (Japanese Unexamined Patent Publication No. 2005-250833) and a non-patent document 1 (“Multi-layer AHB Overview”, ARM Co., Ltd., (2001, 2004)ARM, DVI0045B).

However, the conventional multilayered bus system has the following two problems.

The first problem is that before the transition to the power-saving mode and after the return to the normal operation mode, it is necessary to stop/resume the operations of the bus masters 1b and 1c by software processing based on the CPU 1a, and it will take time to stop or resume the operations actually.

The second problem is that there is a fear that even when the operations of the bus masters 1a through 1c are stopped, the data might remain in the buffers 12a through 12c, and the system clock CLK is stopped while the data of these buffers 12a through 12c are being transferred to the bus slaves 2a and 2b.

For instance, when the system clock CLK is stopped during a write operation where the bus slave 2a connects an asynchronous memory to the outside by means of an asynchronous memory controller, the memory controller has the possibility of being stopped in a state of having outputted a chip selection signal to the corresponding memory. General asynchronous memories such as a static RAM, a flash memory and the like are placed in a power-saving mode when no chip selection signal is given. When the chip selection signal is given, they are respectively brought into an operating state, thereby increasing power consumption. Therefore, each memory is deactivated in a state in which power consumption is large. On the contrary, the power consumption might increase as a whole.

### SUMMARY OF THE INVENTION

The present invention aims to provide a multilayered bus system capable of carrying out transition to a power-saving mode reliably and rapidly.

According to one aspect of the present invention, for attaining the above object, there is provided a multilayered bus system which connects between a plurality of bus masters each including a CPU and a plurality of bus slaves using a plurality of common buses and performs data transfers in sync with a system clock through a plurality of buffer memories for temporarily holding data therein, the multilayered bus system comprising:

a register which holds therein mode setting information for designating a power-saving mode or a normal operation mode supplied from each CPU and outputs a mode setting signal therefrom;

arbiters each of which outputs a response signal for prohibiting access to each of the bus slaves to each of the bus masters when the power-saving mode is designated by the mode setting signal;

a monitor which monitors the presence or absence of a data transfer between each of the bus slaves and each of the buffer memories when the power-saving mode is designated by the mode setting signal, and outputs an end signal when the data transfer is not being performed over a predetermined period of time; and

a clock controller which outputs a control signal for stopping the supply of the system clock when the power-saving mode is designated by the mode setting signal, the response signal is outputted from each of the arbiters and the end signal is outputted from the monitor.

In the present invention, there are provided arbiters each of which outputs a response signal for prohibiting access to each of the bus slaves to each of the bus masters when a power-saving mode is designated by mode setting information supplied from a CPU. It is therefore possible to stop processing of each bus master without depending on software. Since there is provided a clock controller which stops the supply of a system clock, there is no fear that when the power-saving mode is designated, the response signal for prohibiting access is outputted, and an end signal indicating that the respective bus slaves do not perform data transfers for a predetermined period of time is outputted from a monitor, the system clock is stopped during data transfer. Thus, an advantageous effect is brought about in that the transition to the power-saving mode can be carried out reliably and rapidly.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a configuration diagram of a multilayered bus system showing a first embodiment of the present invention;

FIG. 2 is a configuration diagram of a conventional multilayered bus system;

FIG. 3 is a circuit diagram showing examples of a clock controller 20A, arbiters 40a through 40c and a monitor 50 shown in FIG. 1; and

FIG. 4 is a configuration diagram of a multilayered bus system showing a second embodiment of the present invention.

### DETAILED DESCRIPTION OF THE PREFERRED EMBODIMENTS

When first-in first-out buffers (hereinafter called “FIFOs”) capable of outputting empty signals indicative of the absence of data in buffers are used as buffer memories for temporarily holding transfer data therein, a monitor is configured so as to monitor the empty signals of the respective FIFOs when a power-saving mode is designated by a mode setting signal, and output an end signal when no data exist in all FIFOs.

The above and other objects and novel features of the present invention will become more completely apparent from the following descriptions of preferred embodiments when the same is read with reference to the accompanying drawings. The drawings, however, are for the purpose of illustration only and by no means limitative of the invention.

### First Preferred Embodiment

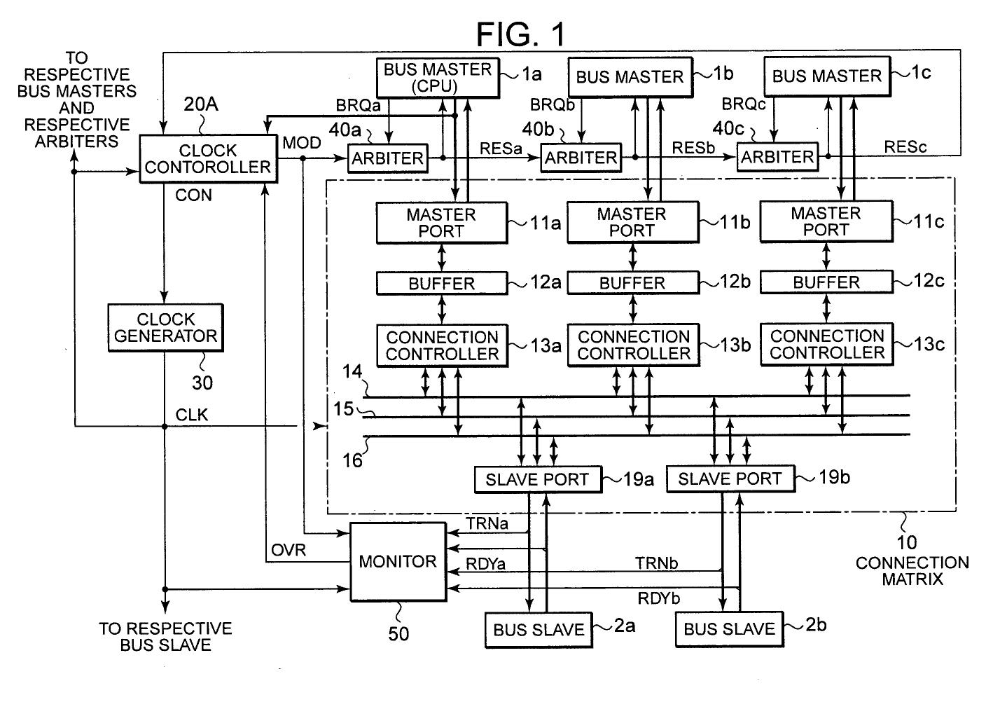

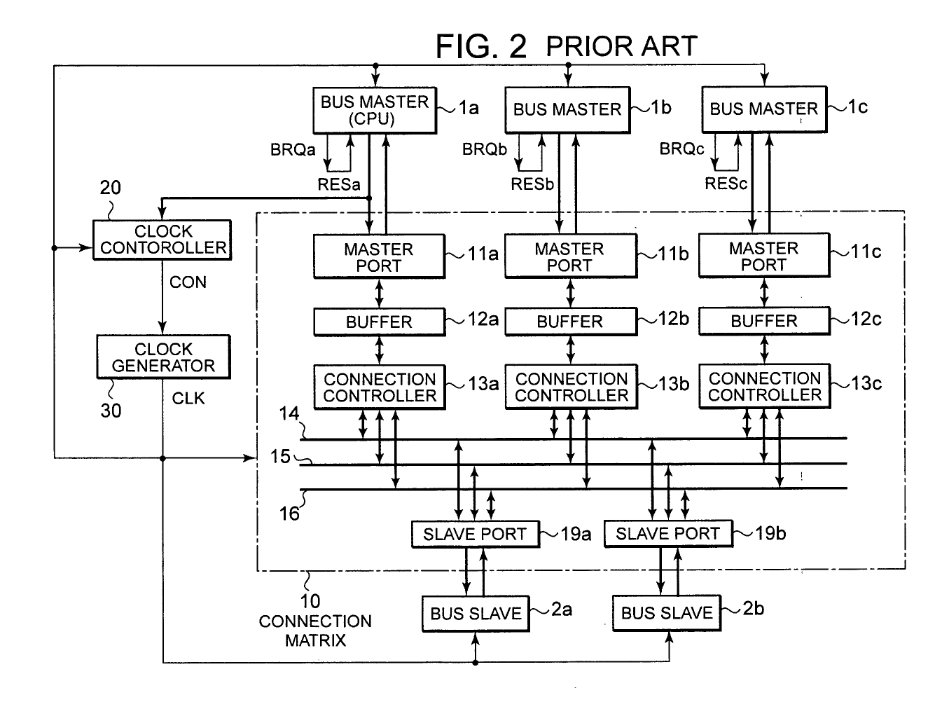

FIG. 1 is a configuration diagram of a multilayered bus system showing a first embodiment of the present invention. Elements common to those shown in FIG. 2 are given common reference numerals respectively.

The multilayered bus system is configured so as to connect between a plurality of bus masters each including a CPU and a plurality of bus slaves using a plurality of common buses and perform data transfers in sync with a system clock through a plurality of buffer memories for temporarily retaining data therein. In a manner similar to FIG. 2, the multilayered bus system is equipped with a connection matrix 10 that connects between bus masters 1a, 1b and 1c and bus slaves 2a and 2b according to requests made from the master side, and a clock generator 30 that generates a system clock CLK.

Incidentally, when the respective bus masters 1a through 1c are connected to the connection matrix 10, they output bus request signals BRQa through BRQC respectively. When the bus masters 1a through 1c obtain connection permission in accordance with response signals RESa through RESc corresponding to the bus request signals BRQa through BRQc, they can gain access to buses. However, when the respective bus masters 1a through 1c are equipped with the common buses corresponding to the number thereof always connectable thereto as in the case of the present multilayered bus system, the bus request signals BRQa through BRQc respectively outputted from the bus masters 1a through 1c are always respectively set to a logical value “1”.

The connection matrix 10 has master ports 11a through 11c to which the bus masters 1a through 1c are respectively connected. Buffers 12a through 12c that temporarily hold write addresses, write data and the like are respectively connected to the master ports 11a through 11c. Connection controllers 13a through 13c, which respectively control connections to the slave side in accordance with the write addresses retained in the buffers, are connected to their corresponding buffers 12a through 12c. These connection controllers 13a through 13c are connected to a plurality of common buses 14, 15 and 16 that constitute a multilayer. Further, the connection matrix 10 has slave ports 19a and 19b to which the bus slaves 2a and 2b are respectively connected. These slave ports 19a and 19b are connected to the common buses 14 through 16.

The clock generator 30 supplies the system clock CLK to the respective sections in accordance with a control signal CON.

Further, the multilayered bus system is provided with a clock controller 20A slightly different in function from the clock controller 20 shown in FIG. 2 as an alternative to the clock controller 20 and additionally provided with arbiters 40a through 40c corresponding to the bus masters 1a through 1c, and a monitor 50 which monitors the states of data transfers by the bus slaves 2a and 2b.

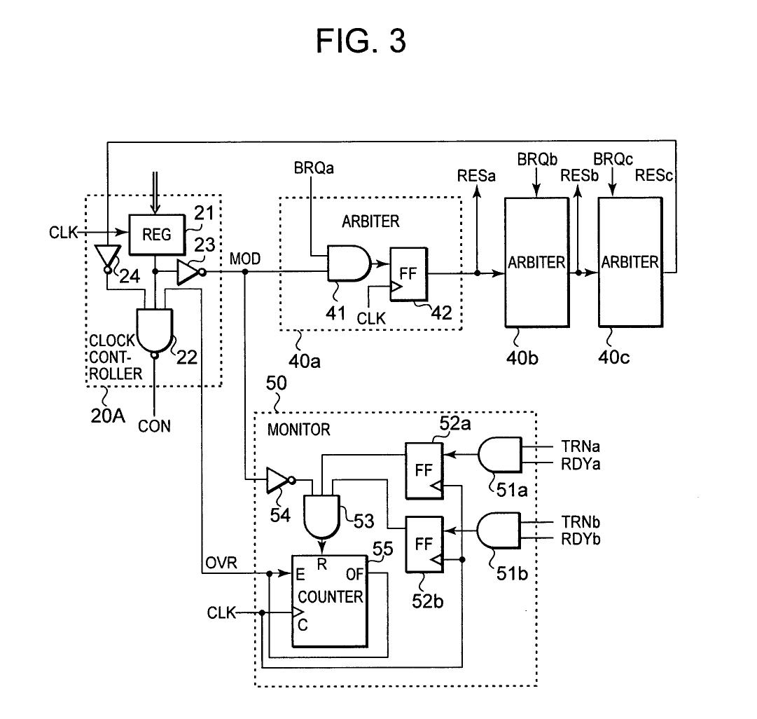

FIG. 3 is a circuit diagram showing one examples of the clock controller 20A, arbiters 40a through 40c and monitor 50 shown in FIG. 1.

The clock controller 20A comprises a register (REG) 21, a three-input NAND gate (hereinafter called “NAND”) 22, and inverters 23 and 24. The register 21 is a one-bit register that holds mode designation information for designating a power-saving mode or normal operation mode from a CPU 1a, in sync with a system clock CLK. A signal outputted from the register 21 is supplied to the NAND 22 and inverted by the inverter 23, which in turn is outputted as a mode designation signal MOD. Further, a response signal RESc outputted from the arbiter 40c is inverted by the inverter 24, which in turn is supplied to the NAND 22. An end or over signal OVR outputted from the monitor 50 is supplied to the NAND 22. Then, the NAND 22 ANDs these and outputs the result of ANDing to the clock generator 30 as a control signal CON.

Any of the arbiters 40a through 40c is identical in circuit configuration. As illustrated as the arbiter 40a by way of example, it comprises an AND gate (hereinafter called “AND”) 41 that ANDs both a response signal (mode designation or setting signal MOD of clock controller 20A in this case) supplied from the pre-stage circuit and a bus request signal BRQa supplied from its corresponding bus master 1a, and a flip-flop (hereinafter called “FF”) 42 which retains a signal outputted from the AND 41 in sync with the system clock CLK. The arbiter 40a is configured so as to output a response signal RESa from the FF 42. The arbiters 40a through 40c are connected in tandem. The final-stage arbiter 40c supplies a response signal RESc outputted therefrom to its corresponding bus master 1c and the clock controller 20A.

The monitor 50 monitors the presence or absence of transfer of data between the respective bus slaves 2a and 2b and the buffers 12a through 12c when the power-saving mode is designated by the mode designation signal MOD, and outputs the end signal OVR when the data transfer is not performed over a predetermined time. The monitor 50 includes an AND 51a which ANDs both a transfer request signal TRNa (corresponding to a signal of “0” when a transfer request is made or a signal of “1” when it is absent) and a response completion signal RDYa (corresponding to a signal brought to “0” when a transfer request is received or a signal brought to “1” when the transfer is completed) both corresponding to signals on the buses on the bus slave 2a side, and an AND 51b which ANDs both a transfer request signal TRNb and a response completion signal RDYb corresponding to signals on the buses on the bus slave 2b side. The outputs of the ANDs 51a and 51b are respectively connected to input terminals of FFs 52a and 52b operated in sync with the system clock CLK. Signals outputted from these FFs 52a and 52b are supplied as two input signals of a three-input AND 53.

The mode designation signal MOD is inverted by an inverter 54, which in turn is supplied to the third input side of the AND 53. The output side of the AND 53 is connected to a reset terminal R of a counter 55. The counter 55 counts the system clock CLK when a signal supplied to its enable terminal E is “0”. When the count value reaches a predetermined value, an output signal at an overflow terminal OF is brought to “1”. The output signal of the overflow terminal OF is supplied to the enable terminal E and also supplied to the clock controller 20A as the end signal OVR. Incidentally, when the signal supplied to enable terminal E is “1”, counting is not performed and the count value is held as it is.

The operation of the multilayered bus system will next be explained with the focus on the transition of its operation from the normal operation mode to the power-saving mode.

In the normal operation mode, mode setting information indicative of a logical value “0” is set to the register 21 of the clock controller 20A. Accordingly, a control signal CON and a mode designation signal MOD outputted from the clock controller 20A are respectively brought to a logical value “1”. Thus, the clock generator 30 supplies a system clock CLK to its corresponding respective sections.

Since a bus request signal BRQa supplied from the bus master 1a is always set to “1” in the arbiter 40a, a response signal RESa is “1”. Since the response signal RESa is supplied to the bus master 1a and the arbiter 40b, the bus master 1a is able to use the corresponding bus. A response signal RESb outputted from the arbiter 40b is also “1” in like manner. Further, a response signal RESc outputted from the arbiter 40c is also “1”. Thus, the bus masters 1a through 1c are all placed in a state of being accessible to the buses.

In the monitor 50, an enable signal EN outputted from the AND 53 becomes “0” and hence the count value of the counter 55 remains 0, thus causing no overflow. Accordingly, an end signal OVR is “0”.

Next, when the processing of the CPU 1a is terminated and proceeds to a standby state, the CPU 1a outputs mode setting information (“1” in this case) for designating the power-saving mode to the clock controller 20A. The clock controller 20A writes the mode setting information supplied from the CPU 1a into the register 21. A signal outputted from the register 21 becomes “1”. Thus, the mode designation signal MOD reaches “0”. Since, at this time, the response signal RESc outputted from the arbiter 40c is “1” and the end signal OVR outputted from the monitor 50 is “0”, the control signal CON becomes “1” and hence the supply of the system clock CLK from the clock generator 30 is continued.

When the mode designation signal MOD is brought to “0” in the arbiter 40a, the response signal RESa is changed to “0” in sync with the following system clock CLK. Thus, new access to the corresponding bus by the bus master 1a is prohibited.

When the response signal RESa is changed to “0” in the arbiter 40b, the response signal RESb is changed to “0” in sync with the following system clock CLK. Thus, new access to the corresponding bus by the bus master 1b is prohibited.

Further, when the response signal RESb is changed to “0” in the arbiter 40c, the response signal RESc is changed to “0” in sync with the following system clock CLK. Thus, new access to the corresponding bus by the bus master 1c is prohibited. The response signal RESc is supplied to the clock controller 20A.

On the other hand, the states of the slave ports 19a and 19b are outputted from the ANDs 51a and 51b in the monitor 50. When the slave ports 19a and 19b are respectively brought into an idle state, signals outputted from the ANDs 51a and 51b are respectively brought to “1”. Since the output signal of the inverter 54 is brought to “1”, an enable signal EN outputted from the AND 53 reaches “1”. Thus, the counter 55 is released from its reset state so that a count-up operation is started.

If bus access is issued from each of the slave ports 19a and 19b during a period in which the counter 55 of the monitor 50 is counting, then the enable signal EN is brought to “0”. Therefore, the count value of the counter 55 is initialized to 0 and hence the counter 55 performs counting again after the corresponding bus on the slave side is brought to the idle state.

When the count value reaches a predetermined value (e.g., 10), a signal outputted from the overflow terminal OF is brought to “1”, which in turn is supplied to the enable terminal E of the counter 55 and outputted to the clock controller 20A as an end signal OVR. Thus, a control signal CON outputted from the clock controller 20A is brought to “0” so that the supply of the system clock CLK from the clock generator 30 is stopped.

Thus, the multilayered bus system according to the first embodiment has the arbiters 40a through 40c which sequentially prohibit bus access to the bus masters 1a through 1c when the mode setting information for designating the power-saving mode is supplied from the CPU 1a, the monitor 50 which monitors whether the transfer of data by each of the bus slaves 2a and 2b is terminated, and the clock controller 20A which outputs the control signal CON for stopping the system clock CLK when it is configured that all the bus masters 1a through 1c have been prohibited from access and the transfer of the data by each of the bus slaves 2a and 2b has been terminated. Thus, the multilayered bus system has the advantage that the transition of its operation to the power-saving mode can be performed reliably and rapidly without depending on software.

### Second Preferred Embodiment

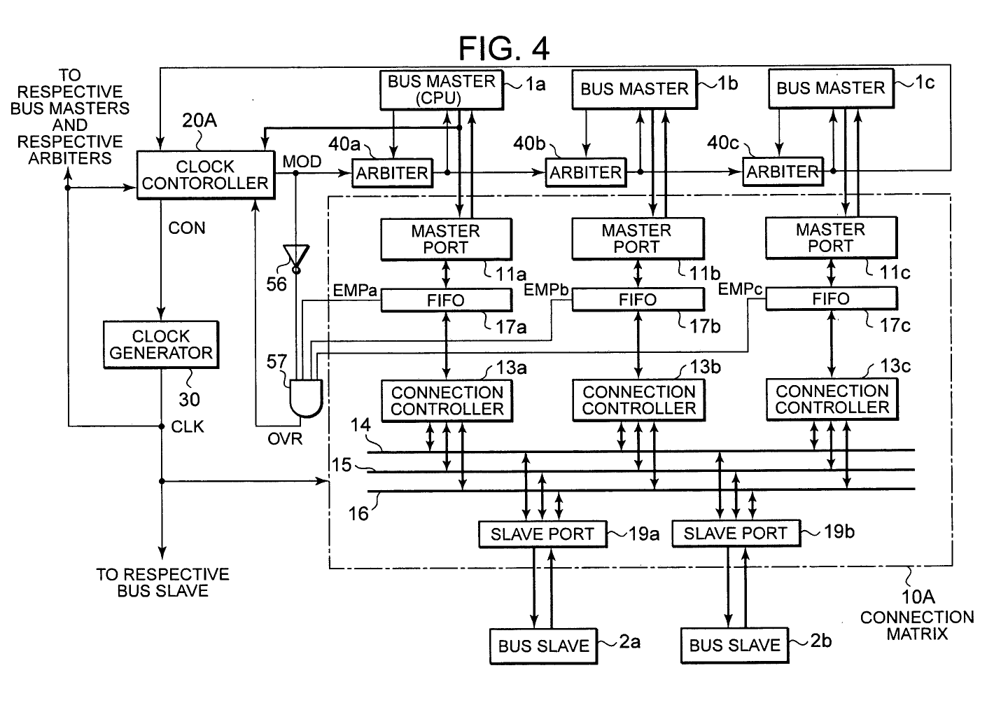

FIG. 4 is a configuration diagram of a multilayered bus system showing a second embodiment of the present invention. Elements common to those shown in FIG. 1 are given common reference numerals respectively.

The multilayered bus system is provided with FIFOs 17a through 17c in place of the buffers 12a through 12c shown in FIG. 1, and a monitor constituted of an inverter 56 and a four-input AND 57 as an alternative to the monitor 50.

The FIFOs 17a through 17c are buffer memories which can be read in a data-written sequence. They are capable of outputting signals indicative of the condition of written data, i.e., indicative of whether the buffers are full or empty. Empty signals EMPa through EMPc indicative of whether the respective FIFOs 17a through 17c are empty are supplied as three input signals of the AND 57. Further, a mode designation signal MOD outputted from a clock controller 20A is inverted by an inverter 56, after which the signal is supplied to the AND 57 as a fourth input signal of the AND 57. The present embodiment is similar to FIG. 1 in other configuration.

The multilayered bus system is similar to the first embodiment in that when a power-saving mode is designated by the mode designation signal MOD, arbiters 40a through 40c prohibit bus access to bus masters 1a through 1c.

On the other hand, the monitoring of the bus access to each of bus slaves 2a and 2b is determined based on each of the empty signals EMPa through EMPc depending on whether each of the FIFOs 17a through 17c is empty. Thus, as compared with the monitor 50 of the first embodiment, an advantage is brought about in that the state of each of the bus slaves 2a and 2b can be determined more reliably.

Incidentally, the present invention is not limited to the above embodiments. Various modifications can be made thereto. As examples for the modifications, the following are cited for instance.

(a) The respective numbers of the bus masters 1a through 1c, bus slaves 2a and 2b and common buses 14 through 16 are not limited to those illustrated in the figures.

(b) The circuit configurations of the clock controller 20A, arbiters 40a through 40c and monitor 50 are not limited to those shown in the figures. For instance, the arbiter 40a or the like may be configured in such a manner that the AND 41 is eliminated and the mode designation signal MOD, the response signal RESa and the like are directly supplied to the FF 42.

(c) The arbiters 40a through 40c are connected in tandem and the response signal RESc of the final-stage arbiter 40c is fed back to the clock controller 20A. However, the arbiters may be configured in such a manner that the mode designation signal MOD is supplied to the arbiters 40a through 40c in parallel and the ANDing of the response signals RESa through RESc of the arbiters 40a through 40c is fed back to the clock controller 20A. It is thus possible to carry out state transition at higher speed.

(d) Although the connection matrixes 10 and 10A respectively have the writing buffers 12 and FIFOs 17, they can be applied even to reading buffers and FIFOs in like manner.

(e) While the counter 55 shown in FIG. 3 is configured so as to overflow when the count value is brought to 10, it is necessary to set this value to the maximum value of the time required to output data to each of the bus slaves 2a and 2b. Since the output of the data is normally terminated at 20 clocks even at the maximum, the value may be set to 10 to 20.

What is claimed is:

1. A multilayered bus system which connects between a plurality of bus masters each including a central processing unit and a plurality of bus slaves using a plurality of common buses and performs data transfers in sync with a system clock through a plurality of buffer memories for temporarily holding data therein, said multilayered bus system comprising:
a register which holds therein mode setting information for designating a power-saving mode or a normal operation mode supplied from said each central processing unit and outputs a mode setting signal therefrom;
arbiters each of which outputs a response signal for prohibiting access to each of the bus slaves to each of the bus masters when the power-saving mode is designated by the mode setting signal;
a monitor which monitors the presence or absence of a data transfer between each of the bus slaves and each of the buffer memories when the power-saving mode is designated by the mode setting signal, and outputs an end signal when the data transfer is not being performed over a predetermined period of time; and
a clock controller which outputs a control signal for stopping the supply of the system clock when the power-saving mode is designated by the mode setting signal, the response signal is outputted from each of the arbiters and the end signal is outputted from the monitor.

2. A multilayered bus system which connects between a plurality of bus masters each including a central processing unit and a plurality of bus slaves using a plurality of common buses and performs data transfers in sync with a system clock through buffer memories for temporarily holding data therein, said multilayered bus system comprising:
a register which holds therein mode setting information for designating a power-saving mode or a normal operation mode supplied from said each central processing unit and outputs a mode setting signal therefrom;
arbiters each of which outputs a response signal for prohibiting access to each of the bus slaves to each of the bus masters when the power-saving mode is designated by the mode setting signal;
a monitor which monitors whether transfer data is being held in each of the buffer memories when the power-saving mode is designated by the mode setting signal and outputs an end signal when data are found not to exist in all of the buffer memories; and
a clock controller which outputs a control signal for stopping the supply of the system clock when the power-saving mode is designated by the mode setting signal, the response signal is outputted from each of the arbiters and the end signal is outputted from the monitor.
